(19) United States
(12) Patent Application Publication
(10) Pub. No.: US 2015/0091816 A1
(43) Pub. Date: Apr. 2, 2015

(54) FLEXIBLE TOUCH APPARATUS AND SYSTEMS THEREOF

(71) Applicant: HengHao Technology Co. LTD, Taoyuan County (TW)

(72) Inventor: Chun-Jung Chen, Taoyuan County (TW)

(73) Assignee: HengHao Technology Co. LTD, Taoyuan County (TW)

(21) Appl. No.: 14/057,453

(22) Filed: Oct. 18, 2013

(30) Foreign Application Priority Data
Sep. 27, 2013 (TW) 102135188

(51) Int. Cl. G06F 3/041

(52) U.S. Cl. CPC G06F 3/041; G06F 2203/04102
USPC 345/173

(57) ABSTRACT

A flexible touch apparatus includes a transparent touch panel; a flexible circuit board connected to the touch panel; a control circuit disposed on a surface of the flexible circuit board to send transmit (TX) signals to the touch panel and process receive (RX) signals from the touch panel; and a signal connector disposed on the flexible circuit board to receive output signals of the control circuit.

### BACKGROUND OF THE INVENTION

1. Field of the Invention

The present invention generally relates to a flexible touch apparatus, and more particularly to a flexible touch apparatus in company with a display or a computer.

2. Description of Related Art

A conventional touch screen is designed and manufactured by bonding or integrating a touch module with a display module. As a result, manufacturing specifications of both the touch module and the display module should be mutually matched, and cost and time of manufacturing the touch screen thus cannot be substantially reduced and yield cannot be substantively increased. The touch module and the display module of the touch screen shipped out of factories cannot be used separately. When only one of the touch module and the display module is required in some applications, the other one of the modules becomes wasted. Moreover, as the conventional touch screens are usually bonded with electronic devices (such as computers), the touch screens are not conveniently portable.

A need has thus arisen to propose a novel touch apparatus that is portable and is capable of accompanying other electronic devices to expand usage.

### SUMMARY OF THE INVENTION

In view of the foregoing, it is an object of the embodiment of the present invention to provide a flexible touch apparatus that is flexible and portable, and may accompany a display to result in a touch display system, or accompany a computer to result in a computer system with positioning touch function.

According to one embodiment, a flexible touch apparatus includes a transparent touch panel, a flexible circuit board, a control circuit and a signal connector. The flexible circuit board is connected to the touch panel. The control circuit is disposed on a surface of the flexible circuit board to send transmit (TX) signals to the touch panel and process receive (RX) signals from the touch panel. The signal connector is disposed on the flexible circuit board to receive output signals of the control circuit. In one embodiment, the flexible touch apparatus adaptively covers at least a portion of a surface of a display, thereby resulting in a touch display system. In another embodiment, the signal connector is electrically coupled to the computer via a cable to result in a computer system with positioning touch function.

### BRIEF DESCRIPTION OF THE DRAWINGS

FIG. 1A shows a perspective view of a flexible touch apparatus according to one embodiment of the present invention;

FIG. 1B shows a perspective view of the flexible touch apparatus of FIG. 1A being rolled up;

FIG. 2 shows a side view of the touch panel of FIG. 1A;

FIG. 3A shows a perspective view of the flexible touch apparatus of FIG. 1A in company with a display to build a touch display system according to a first specific embodiment of the present invention;

FIG. 3B shows a perspective view of the flexible touch apparatus of FIG. 1A in company with a display to build a touch display system according to a modified first specific embodiment of the present invention; and

FIG. 4 shows a perspective view of the flexible touch apparatus of FIG. 1A in company with a computer to build a computer system with positioning touch function according to a second specific embodiment of the present invention.

### DETAILED DESCRIPTION OF THE INVENTION

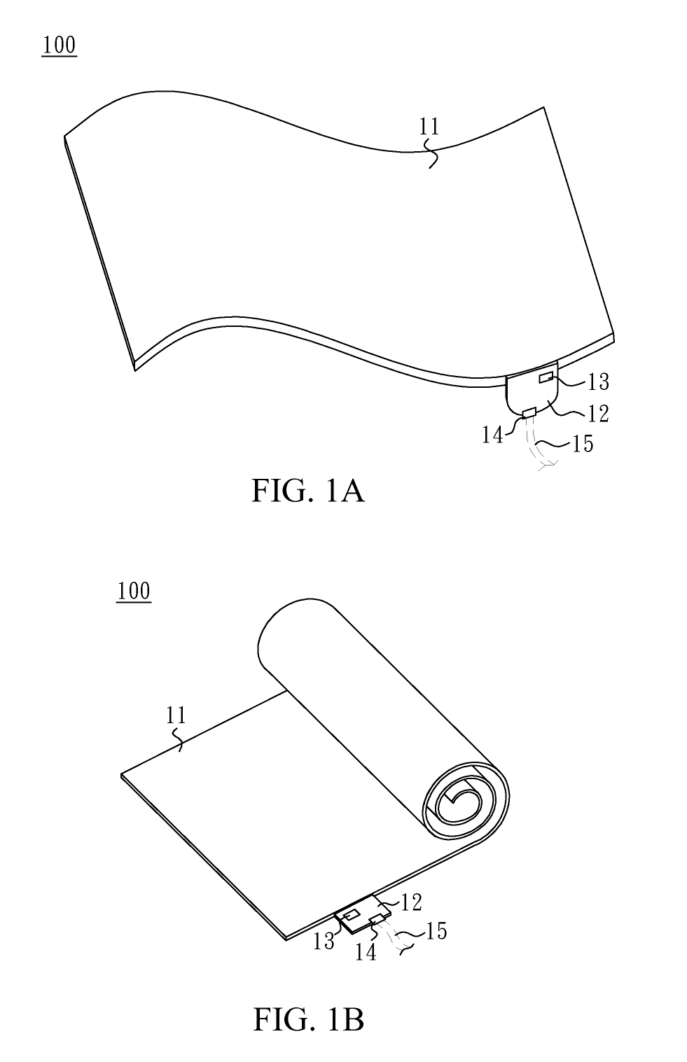

FIG. 1A shows a perspective view of a flexible touch apparatus 100 according to one embodiment of the present invention. The flexible touch apparatus 100 is flexible and may be rolled up, as shown in FIG. 1B, to accommodate portability.

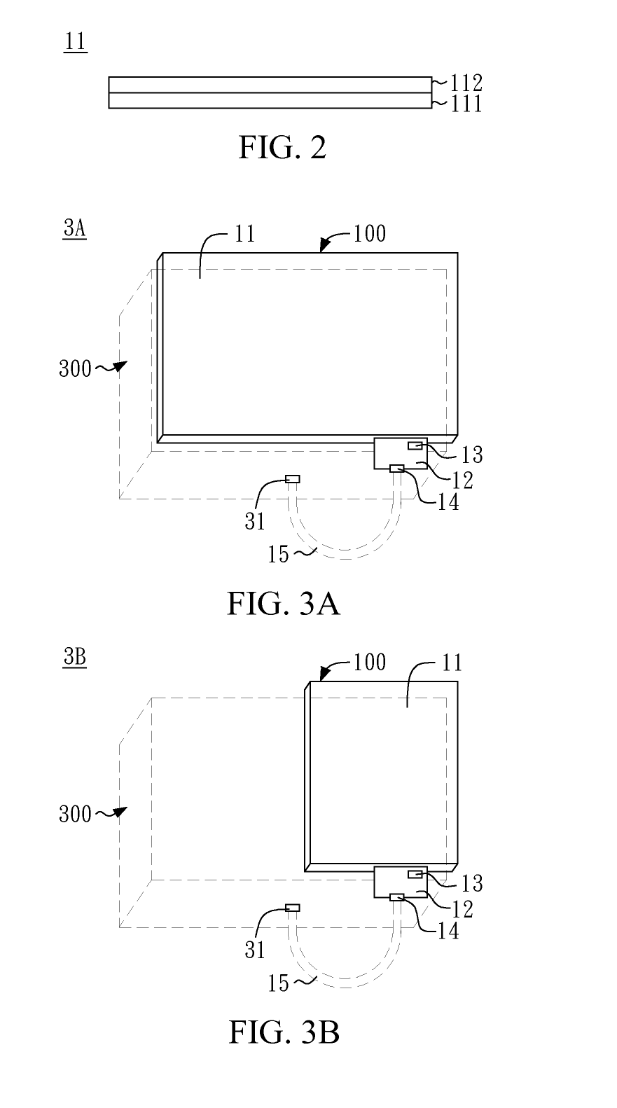

The flexible touch apparatus 100 of the embodiment mainly includes a touch panel 11, a flexible circuit board 12, a control circuit 13 and a signal connector 14. FIG. 2 shows a side view of the touch panel 11 of FIG. 1A, which mainly includes a flexible substrate 111 and a sensing layer 112 disposed on the flexible substrate 111. Compared to a conventional rigid (or inflexible) touch panel, the touch panel 11 of the embodiment does not include any rigid substrate (e.g., glass substrate) or rigid cover layer. Therefore, the touch panel 11 of the embodiment may be called a film sensor.

According to specific requirements, the flexible substrate 111 of the embodiment may be preferably made of a transparent insulating material, such as Polyethylene terephthalate (PET), Polycarbonate (PC), Polymethyl methacrylate (PMMA), Cyclic olefin polymer (COP), Cyclic olefin copolymer (COC), Triacetyl cellulose, (TAC), Poly propylene (PP) or Poly styrene (PS).

According to specific requirements, the sensing layer 112 of the embodiment may be preferably made of a transparent conductive material, such as indium tin oxide (ITO), indium zinc oxide (IZO), metal nanowires or metal nanonets. The sensing layer 112 may include at least one sensing sub-layer, and may include an insulating layer or layers to facilitate electrical insulation among plural insulating sub-layers. The arrangement and pattern of a conventional touch panel may be adapted to the insulating sub-layer of the embodiment.

The flexible circuit board 12 (such as a flexible printed circuit board) of the embodiment may be physically connected to the touch panel 11, and be electrically coupled to conductive traces (not shown) of the touch panel 11, such that the conductive traces may be electrically coupled to the control circuit 13 (such as a control integrated circuit or chip). The control circuit 13 is disposed on a surface of the flexible circuit board 12, and is configured to send transmit (TX) signals to TX electrodes of the touch panel 11, and to process receive (RX) signals of RX electrodes of the touch panel 11. The signal connector 14 is disposed on the flexible circuit board 12 in order to receive output signals of the control circuit 13 and then transfer the output signals to other electronic devices via a cable 15. The signal connector 14 may be compliant with a standard regulation (such as Universal Serial Bus (USB)) or a proprietary regulation.

FIG. 3A shows a perspective view of the flexible touch apparatus 100 in company with a display 300 (e.g., a liquid crystal display) to build a touch display system 3A according to a first specific embodiment of the present invention. The touch panel 11 of the embodiment is transparent, such that image of the display 300 may be perceived from top of the touch panel 11 that covers a top surface of the touch panel 11. The flexible touch apparatus 100 may be electrically coupled to a connector 31 (e.g., USB connector) of the display 300 via the signal connector 14 (e.g., USB connector) and the cable 15. Accordingly, the touch display system 3A, composed of the flexible touch apparatus 100 and the display 300, may perform functions of a touch screen. The flexible touch apparatus 100 of the embodiment may be configured as an add-on, plug-in or accessory device to act as an independent electronic (input) device, instead of being configured to be bonded or integrated with a display module. Therefore, the embodiment may possess some advantages over the conventional touch screen that is manufactured by bonding or integrating a touch module with a display module. For example, a single portable flexible touch apparatus 100 may adaptively accompany plural displays 300 to cut down on the amount of displays 300. For another example, plural flexible touch apparatuses 100 with different types or patterns may selectively accompany a display 300 to realize diversification. Moreover, compared to the conventional touch screen, the flexible touch apparatus 100 of the embodiment may be manufactured without regarding manufacturing specifications of display module. Therefore, cost and time of manufacturing the flexible touch apparatus 100 may be substantially reduced and yield may be greatly increased.

FIG. 3B shows a perspective view of the flexible touch apparatus 100 in company with a display 300 (e.g., a liquid crystal display) to build a touch display system 3B according to a modified first specific embodiment of the present invention. In the embodiment, a size of the flexible touch apparatus 100 is smaller than a size of the display 300. When the display 300 is partially covered with the flexible touch apparatus 100, the covered area may perform functions of a touch screen, while uncovered area may simply perform display functions. Accordingly, in addition to the advantages of the embodiment shown in FIG. 3A, the embodiment of FIG. 3B may further form a composite touch display system 3B with a partial area capable of performing touch and display while the other area capable of simply performing display. The composite touch and display cannot be realized by a conventional touch screen without consuming substantive cost and time.

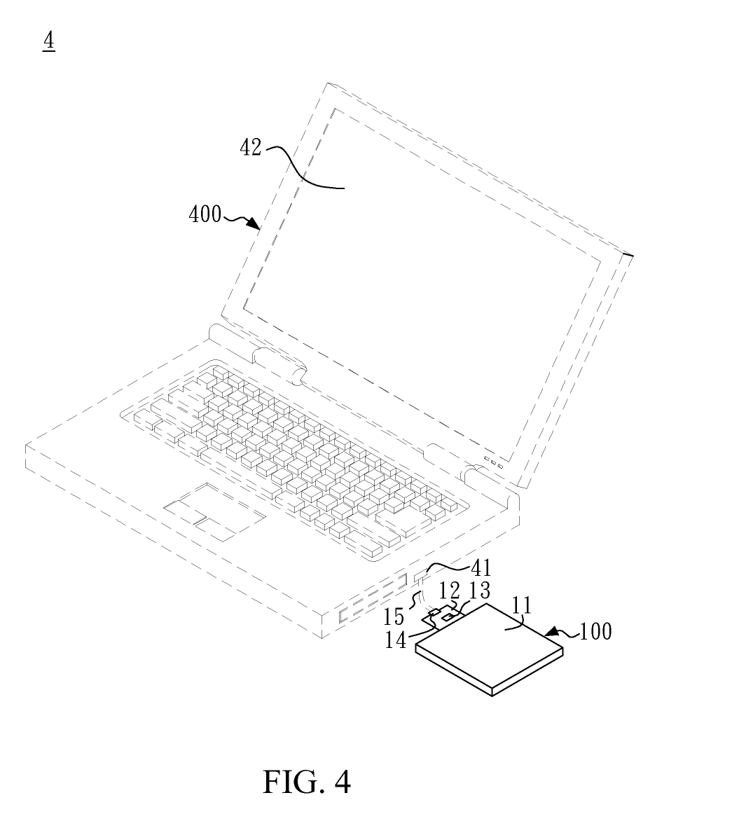

FIG. 4 shows a perspective view of the flexible touch apparatus 100 in company with a computer 400 (e.g., a notebook computer) to build a computer system 4 with positioning touch function according to a second specific embodiment of the present invention. The touch panel 11 of the embodiment may be opaque (but may be transparent otherwise), and may be electrically coupled to a connector 41 (e.g., USB connector) of the computer 400 via the signal connector 14 (e.g., USB connector) and the cable 15. A size of the touch panel 11 may be smaller than (but may be the same as or larger than) a size of a screen 42 of the computer 400. Accordingly, the computer system 4 with positioning touch function, composed of the flexible touch apparatus 100 and the computer 400, may perform positioning and pointing function. The flexible touch apparatus 100 of the embodiment may be configured as an add-on, plug-in or accessory device to act as an independent electronic (input) device or touch pad device, which possesses a pointing function similar to a conventional mouse, and possesses a positioning function not found in the mouse. Compared with the conventional (rigid) touch panel, the flexible touch apparatus 100 of the embodiment is flexible to accommodate portability, and may be rolled up to accommodate storage. It is noted that the flexible touch apparatus 100 of the embodiment (FIG. 4) may be made transparent to be adopted not only as the computer system 4 with positioning touch function as shown in FIG. 4, but also as the touch display system 3A/3B as shown in FIG. 3A/3B.

Although specific embodiments have been illustrated and described, it will be appreciated by those skilled in the art that various modifications may be made without departing from the scope of the present invention, which is intended to be limited solely by the appended claims.

What is claimed is:

1. A flexible touch apparatus, comprising:
a touch panel that is transparent;
a flexible circuit board, connected to the touch panel;
a control circuit, disposed on a surface of the flexible circuit board to send transmit (TX) signals to the touch panel and process receive (RX) signals from the touch panel; and
a signal connector, disposed on the flexible circuit board to receive output signals of the control circuit.

2. The apparatus of claim 1, wherein the touch panel comprises a film sensor.

3. The apparatus of claim 1, wherein the touch panel comprises:
a flexible substrate; and
a sensing layer disposed on the flexible substrate.

4. The apparatus of claim 3, wherein the flexible substrate comprises Polyethylene terephthalate (PET), Polycarbonate (PC), Polymethyl methacrylate (PMMA), Cyclic olefin polymer (COP), Cyclic olefin copolymer (COC), Triacetyl cellulose, (TAC), Poly propylene (PP) or Poly styrene (PS).

5. A touch display system, comprising:
a flexible touch apparatus comprising:
a touch panel that is transparent;
a flexible circuit board, connected to the touch panel;
a control circuit, disposed on a surface of the flexible circuit board to send transmit (TX) signals to the touch panel and process receive (RX) signals from the touch panel;
a signal connector, disposed on the flexible circuit board to receive output signals of the control circuit; and
a display, at least a portion of a surface of the display being adaptively covered with the flexible touch apparatus, and the signal connector being electrically coupled to the display via a cable.

6. The system of claim 5, wherein another portion of surface of the display is not covered with the flexible touch apparatus.

7. The system of claim 5, wherein the touch panel comprises a film sensor.

8. The system of claim 5, wherein the touch panel comprises:
a flexible substrate; and
a sensing layer disposed on the flexible substrate.

9. The system of claim 8, wherein the flexible substrate comprises Polyethylene terephthalate (PET), Polycarbonate (PC), Polymethyl methacrylate (PMMA), Cyclic olefin polymer (COP), Cyclic olefin copolymer (COC), Triacetyl cellulose, (TAC), Poly propylene (PP) or Poly styrene (PS).

10. A computer system with positioning touch function, the system comprising:
a flexible touch apparatus comprising:
a touch panel;
a flexible circuit board, connected to the touch panel;
a control circuit, disposed on a surface of the flexible circuit board to send transmit (TX) signals to the touch panel and process receive (RX) signals from the touch panel;
a signal connector, disposed on the flexible circuit board to receive output signals of the control circuit; and
a computer, the signal connector being electrically coupled to the computer via a cable.

11. The system of claim 10, wherein the touch panel comprises a film sensor.

12. The system of claim 10, wherein the touch panel comprises:
a flexible substrate; and
a sensing layer disposed on the flexible substrate.

13. The system of claim 12, wherein the flexible substrate comprises Polyethylene terephthalate (PET), Polycarbonate (PC), Polymethyl methacrylate (PMMA), Cyclic olefin polymer (COP), Cyclic olefin copolymer (COC), Triacetyl cellulose, (TAC), Poly propylene (PP) or Poly styrene (PS).
